(19) United States
(12) Patent Application Publication
(10) Pub. No.: US 2026/0163279 A1
(43) Pub. Date: Jun. 11, 2026

(54) TERMINAL FITTING

(71) Applicant: SUMITOMO WIRING SYSTEMS, LTD., Mie (JP)

(72) Inventor: Akihisa OGAWA, Mie (JP)

(21) Appl. No.: 19/126,646

(22) PCT Filed: Oct. 17, 2023
(86) PCT No.: PCT/JP2023/037496

§ 371 Date: May 2, 2025

(30) Foreign Application Priority Data
Nov. 7, 2022 (JP) 2022-177845

(51) Int. Cl. H01R 13/11; H01R 13/03

(52) U.S. Cl. CPC H01R 13/113; H01R 13/03

(57) ABSTRACT

This terminal metal fitting (10) includes: a cylindrical connection part (11); an elastically deformable elastic contact part (34) disposed on the inner side of the connection part (11); and a contact part (39) provided to the elastic contact part (34). A mating terminal metal fitting (90) is disposed inside the connection part (11) along the front-rear direction through an opening in the front end of the connection part (11). The contact part (39) has a top portion (43), and a front inclined portion (44) inclining and extending to the front from the top portion (43). The front inclined portion (44) of the contact part (39) includes a gradually-thinning wall portion (46) that is gradually reduced in thickness toward the top portion (43).

### TECHNICAL FIELD

The present disclosure relates to a terminal fitting.

### BACKGROUND

A terminal fitting disclosed in Patent Document 1 is provided with a resilient contact portion (contact part) and a top portion (electromagnetic contact dome) provided on the resilient contact portion to contact a mating terminal fitting (facing terminal). The resilient contact portion has a “free mechanical dome transition region” on a front side and a “fixed mechanical dome transition region” on a rear side, out of the front and rear sides across the top portion. Terminal fittings of this type are also disclosed in Patent Document 1 and Patent Document 2.

### PRIOR ART DOCUMENT

### Patent Document

Patent Document 1: JP 2021-177482 A (FIG. 9)
Patent Document 2: JP 2001-210418 A
Patent Document 3: JP 2015-103410 A

### SUMMARY OF THE INVENTION

### Problems to be Solved

In the terminal fitting disclosed in Patent Document 1, a plate thickness of the resilient contact portion is suddenly changed to thin the entire top portion in each of the “free mechanical dome transition region” and the “fixed mechanical dome transition region” (hereinafter, merely referred to as “transition regions”). Thus, there is a concern that stress concentrates in the transition regions when the resilient contact portion contacts the mating terminal fitting to be resiliently deformed, and contact resistance may be enhanced in the transition regions and workability may be deteriorated when the terminal fitting and the mating terminal fitting are connected.

Accordingly, the present disclosure aims to provide a terminal fitting capable of improving workability at the time of connection to a mating terminal fitting.

### Means to Solve the Problem

The present disclosure is directed to a terminal fitting with a tubular connecting portion, a resiliently deformable resilient contact portion arranged inside the connecting portion, and a contact point portion provided on the resilient contact portion, a mating terminal fitting being arranged along a front-rear direction inside the connecting portion through an opening on a front end of the connecting portion, and the contact point portion including a top portion for contacting the mating terminal fitting and a front inclined portion extending obliquely forward from the top portion, the front inclined portion being provided with a gradually thinned portion gradually thinned toward the top portion.

### Effect of the Invention

According to the present disclosure, it is possible to provide a terminal fitting capable of improving connection workability at the time of connection to a mating terminal fitting.

### BRIEF DESCRIPTION OF THE DRAWINGS

FIG. 1 is a perspective view of a terminal fitting according to one embodiment of the present disclosure.

FIG. 2 is a perspective view of the terminal fitting when viewed from a direction different from that in FIG. 1.

FIG. 3 is a front view of the terminal fitting.

FIG. 4 is a plan view in section of a connecting portion.

FIG. 5 is a side view in section of the connecting portion.

FIG. 6 is a side view in section showing a state where a mating terminal fitting is inserted inside the connecting portion.

FIG. 7 is a side view in section enlargedly showing a contact point portion of the connecting portion.

FIG. 8 is a graph showing a relationship of an insertion force and a stroke of the mating terminal fitting inserted inside the connecting portion.

### DETAILED DESCRIPTION TO EXECUTE THE INVENTION

### Description of Embodiments of Present Disclosure

First, embodiments of the present disclosure are listed and described.

(1) The terminal fitting of the present disclosure is provided with a tubular connecting portion, a resiliently deformable resilient contact portion arranged inside the connecting portion, and a contact point portion provided on the resilient contact portion, a mating terminal fitting being arranged along a front-rear direction inside the connecting portion through an opening on a front end of the connecting portion, and the contact point portion including a top portion for contacting the mating terminal fitting and a front inclined portion extending obliquely forward from the top portion, the front inclined portion being provided with a gradually thinned portion gradually thinned toward the top portion.

The contact point portion of the above configuration can have a surface area wider than a contact point portion continuous in the front-rear direction while having a constant thickness since the gradually thinned portion is included. Thus, according to the above configuration, since stress acting on the contact point portion can be widely dispersed in the gradually thinned portion when the resilient contact portion contacts the mating terminal fitting, workability such as insertion workability can be improved when the terminal fitting and the mating terminal fitting are connected.

(2) Preferably, a surface of the contact point portion on a side opposite to a surface for contacting the mating terminal fitting is a curved surface curved toward a top of the top portion.

According to the above configuration, the stress acting on the contact point portion can be widely dispersed over the entire curved surface when the resilient contact portion and the mating terminal fitting contact. Further, the curved surface can be easily formed by being struck by a press-working punch.

(3) A pure metal plating layer may be formed on a surface of the resilient contact portion, and a thickness of the pure metal plating layer of the contact point portion may be smaller than a thickness of the pure metal plating layer around the contact point portion on the surface of the resilient contact portion facing the mating terminal fitting.

The mating terminal fitting of the above configuration can contact the thin pure metal plating layer on the top portion of the contact point portion. Thus, in the process of inserting the mating terminal fitting into the connecting portion, plating scraping of the pure metal plating layer can be reduced in amount and stress generated in the contact point portion during the insertion of the mating terminal fitting can be reduced.

(4) The connecting portion may include a receiving portion capable of sandwiching the mating terminal fitting between the resilient contact portion and the receiving portion at a position facing the resilient contact portion, the resilient contact portion may be strip-like, include a front extending portion extending to approach the receiving portion toward a rear side from a base end portion provided on a front end side of the connecting portion and be resiliently deformable in a plate thickness direction of the front extending portion with the base end portion as a fulcrum, the front inclined portion may be arranged on a rear end side of the front extending portion and a relational expression of ½≤tt/ft≤¾ may be satisfied when tt denotes a plate thickness of the top portion.

According to the above configuration, it is possible to provide the contact point portion having a plate thickness suitable to improve workability during insertion workability when the resilient contact portion and the mating terminal fitting are connected. If tt/ft<½, the plate thickness of the top portion becomes excessively small and it becomes difficult to obtain a contact load of the resilient contact portion and the mating terminal fitting. If tt/ft>¾, it becomes difficult to sufficiently exhibit an action to disperse the stress by the gradually thinned portion.

### Details of Embodiment of Present Disclosure

A specific example of the present disclosure is described below with reference to the drawings. Note that the present invention is not limited to these illustrations, but is represented by claims and includes all changes in the scope of claims and in the meaning and scope of equivalents.

### Embodiment

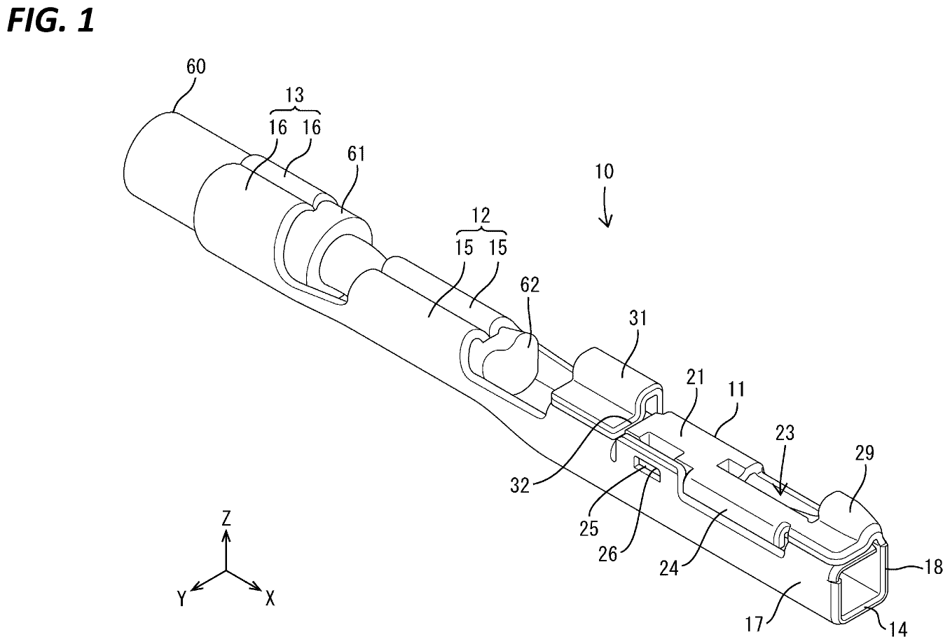

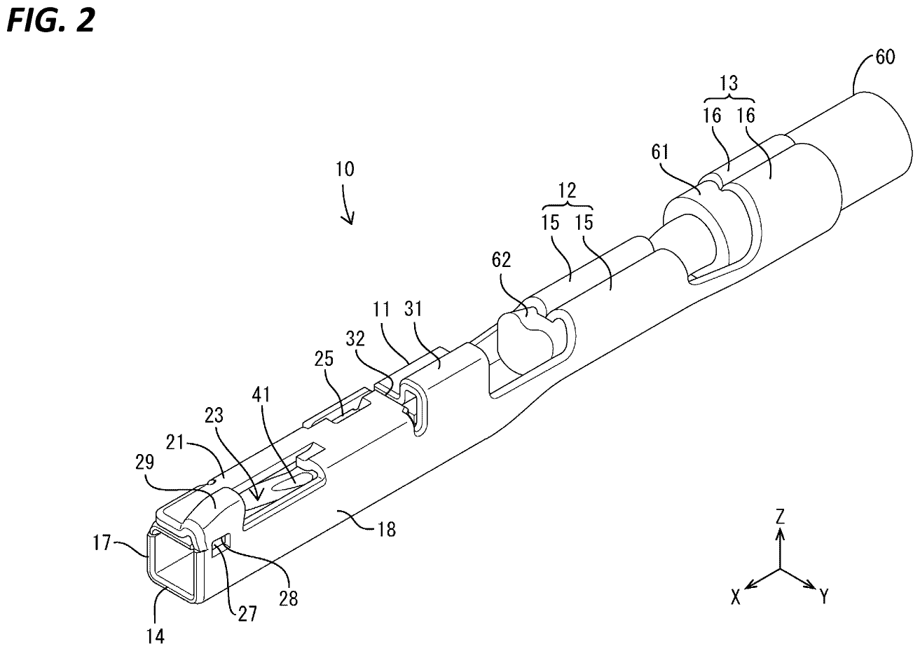

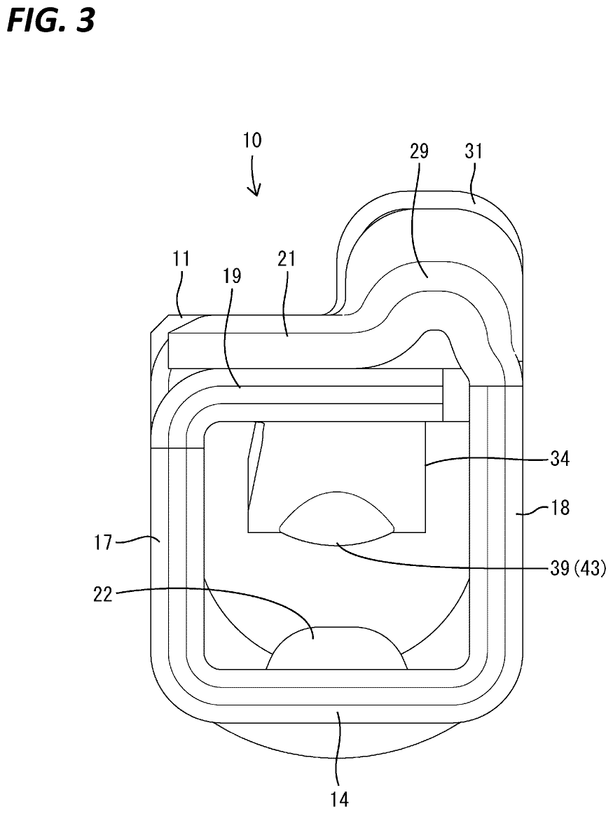

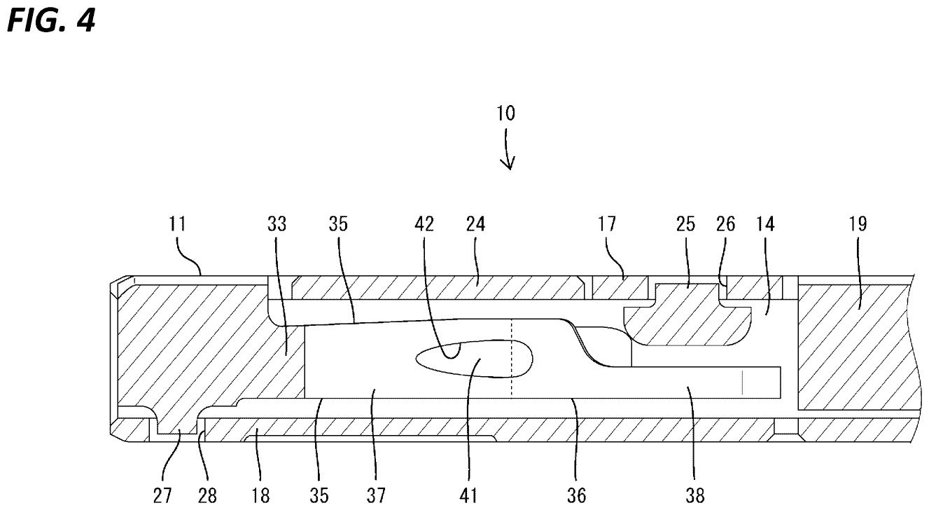

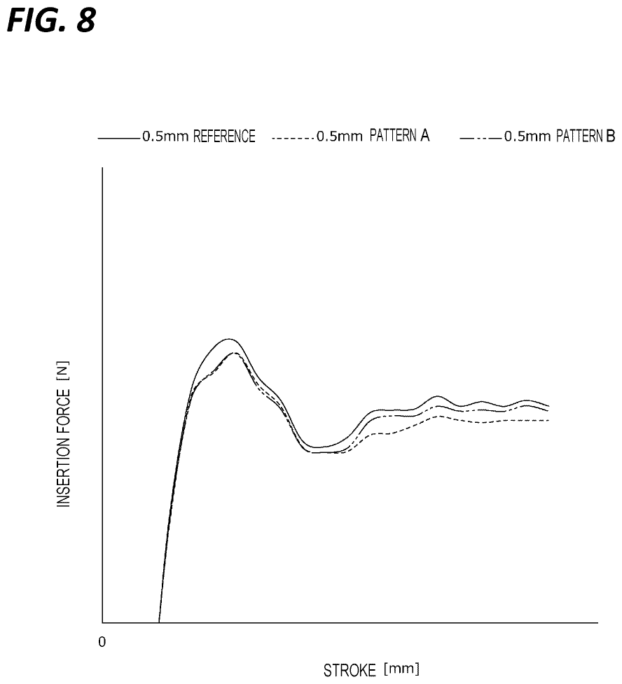

A terminal fitting 10 according to one embodiment of the present disclosure is integrally formed, such as by bending an electrically conductive metal plate. The terminal fitting 10 is provided with a connecting portion 11 and a barrel portion 12, 13 arranged in parallel to each other. Note that, in the following description, an arrangement direction of the connecting portion 11 and the barrel portion 12, 13 is referred to as a front-rear direction, and a side where the connecting portion 11 is located with respect to the barrel portion 12, 13 is referred to as a front side. A vertical direction is based on a vertical direction of each figure except FIGS. 4 and 8. A lateral direction is based on a lateral direction of FIG. 3. The vertical direction is synonymous with a height direction, and the lateral direction is synonymous with a width direction. X, Y and Z of FIGS. 1 and 2 respectively indicate a front side, a left side and an upper side. These direction references are for convenience and do not necessarily coincide with directions in a state where an unillustrated connector accommodating the terminal fitting 10 is installed in an unillustrated vehicle or the like.

### (Structure of Terminal Fitting)

As shown in FIGS. 1 and 2, the terminal fitting 10 is formed into a shape elongated in the front-rear direction. The terminal fitting 10 includes a bottom plate portion 14 in the form of a strip extending over an entire length in the front-rear direction.

The barrel portion has a rear part of a bottom plate portion 14 and includes a wire barrel portion 12 and an insulation barrel portion 13. The wire barrel portion 12 is arranged forward of the insulation barrel portion 13 and includes a pair of wire barrel pieces 15 respectively rising from both left and right end sides of the rear part of the bottom plate portion 14. The wire barrel portion 12 is crimped and electrically connected to a core wire 62 exposed by removing a coating 61 in an end part of a coated wire 60. The insulation barrel portion 13 includes a pair of insulation barrel pieces 16 respectively rising from the both left and right end sides of the rear part of the bottom plate portion 14, and is crimped and mechanically connected to the coating 61 in the end part of the coated wire 60.

The connecting portion 11 is in the form of a rectangular tube long in the front-rear direction and is open on both front and rear sides. As shown in FIG. 3, the connecting portion 11 includes a front part of the bottom plate portion 14, a pair of side plate portions 17, 18 respectively rising from both left and right end sides of the front part of the bottom plate portion 14, an inner plate portion 19 bent toward the side plate portion 18 on the other side (right side of FIG. 3) from the upper end of the side plate portion 17 on one side (left side of FIG. 3) and arranged to face the bottom plate portion 14, and an outer plate portion 21 bent toward the side plate portion 17 on the one side from the upper end of the side plate portion 18 on the other side and overlaid on an upper surface side of the inner plate portion 19 (outer surface side of the connecting portion 11).

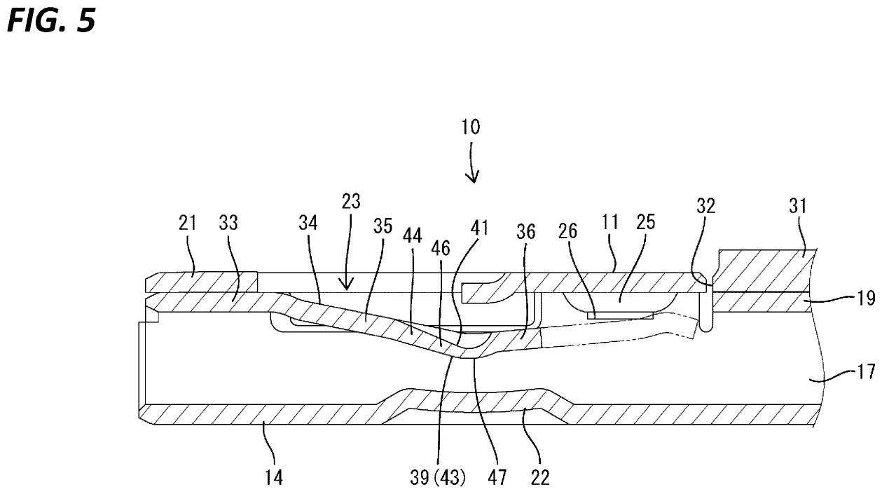

As shown in FIG. 5, a receiving portion 22 shaped to bulge inwardly of the connecting portion 11 is provided in a lateral central part of the front part of the bottom plate portion 14. The receiving portion 22 is in the form of a rib extending in the front-rear direction, and a central part in the front-rear direction thereof is formed into a curved shape recessed from both front and rear end sides.

As shown in FIG. 1, the outer plate portion 21 is provided with a through hole 23 penetrating in a plate thickness direction. The through hole 23 is arranged near the other side of the outer plate portion 21 (side where the side plate portion 18 on the other side is located). A first locking piece 24 and a second locking piece 25 are provided side by side in the front-rear direction on an end part of the outer plate portion 21 on the one side. The first locking piece 24 is arranged laterally side by side with the through hole 23, bent at the end part of the outer plate portion 21 on the one side and supported on the upper end of the side plate portion 17 on the one side. The second locking piece 25 is arranged rearward of the first locking piece 24, bent into a stepped shape, and inserted and locked into a second locking hole 26 open in the side plate portion 17 on the one side (see FIG. 4).

As shown in FIG. 2, a third locking piece 27 is provided at a position forward of the through hole 23 on an end part of the inner plate portion 19 on the other side. As shown in FIG. 4, the third locking piece 27 is inserted and locked into a third locking hole 28 open in the side plate portion 18 on the other side. By supporting the first locking piece 24 on the side plate portion 17 on the one side, inserting and locking the second locking piece 25 into the second locking hole 26 and inserting and locking the third locking piece 27 into the third locking hole 28 in this way, the rectangular tube shape of the connecting portion 11 is maintained.

Further, as shown in FIGS. 1 and 2, a first protrusion 29 having an inverted U shape (curved shape) bulging upward (outwardly of the connecting portion 11) is provided on a front end side of the outer plate portion 21. The rear end of the first protrusion 29 constitutes the front end of the through hole 23. A second protrusion 31 having an inverted U shape (curved shape) bulging upward is also provided on a rear end side of the outer plate portion 21. The second protrusion 31 bulges more than the first protrusion 29 (see FIG. 3). A cut portion 32 is provided on the rear end side of the outer plate portion 21 by being cut along the width direction while defining the front end of the second protrusion 31. As shown in FIG. 1, the cut portion 32 is arranged rearward of the second locking piece 25.

Although not shown, the terminal fitting 10 is inserted into a cavity of a connector housing from behind. The cavity is formed with a projecting locking lance. The terminal fitting 10 is inserted into the cavity and the locking lance faces the through hole 23 to be lockable to the rear end of the first protrusion 29, whereby the terminal fitting 10 is held in the connector housing in a state restricted from coming out rearward. Here, the second protrusion 31 is fit into a guiding groove communicating with the cavity and guides an inserting operation of the terminal fitting 10.

As shown in FIG. 5, the inner plate portion 19 is composed of a base end portion 33 to be held in close contact with the lower surface of the outer plate portion 21 on a front end side and a resilient contact portion 34 cantilevered rearward from the base end portion 33. As shown in FIG. 4, the third locking piece 27 is formed to protrude on an end part of the base end portion 33 on the other side.

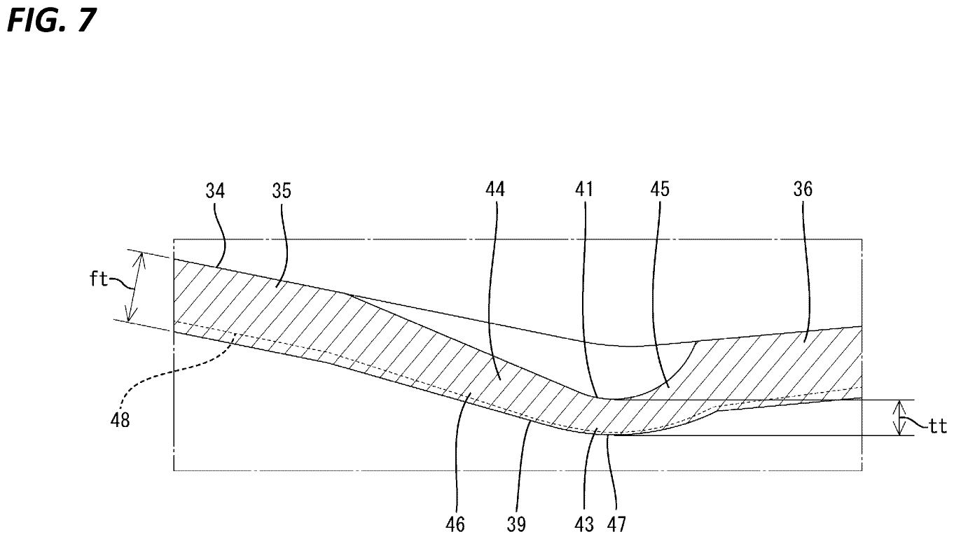

The resilient contact portion 34 is resiliently deformable in the vertical direction (plate thickness direction) with the base end portion 33 as a fulcrum. As shown in FIG. 5, the resilient contact portion 34 includes a front extending portion 35 extending obliquely downward to approach the receiving portion 22 from the base end portion 33 toward a rear side and a rear extending portion 36 extending obliquely upward to be separated from the receiving portion 22 toward the rear side except at a rear end side. The rear end side of the rear extending portion 36 is bent downward and the upper surface thereof is facing the outer plate portion 21. Each of the front and rear extending portions 35, 36 has a constant vertical thickness (later-described plate thickness ft shown in FIG. 7) except at a contact point portion 39 to be described later.

As shown in FIG. 4, the front extending portion 35 includes a wide portion 37 extending rearward from the base end portion 33. The rear extending portion 36 includes the wide portion 37 continuous from the front extending portion 35 and a narrow portion 38 extending from one lateral end part of the rear end of the wide portion 37 while having a constant lateral width. The narrow portion 38 has a smaller lateral width than the wide portion 37 and is arranged laterally side by side with the second locking piece 25 to avoid interference with the second locking piece 25.

As shown in FIG. 5, the resilient contact portion 34 includes the contact point portion 39 in the form of a dome bulging downward in an intermediate part in the front-rear direction including a boundary between the front and rear extending portions 35, 36. The upper surface of the contact point portion 39 is configured into a curved surface 41 curved and recessed from the surrounding by striking the upper surface of the resilient contact portion 34 by an unillustrated press-working punch. As shown in FIG. 4, the curved surface 41 includes an outer peripheral edge part 42 having a teardrop shape extending long in the front-rear direction and gradually reduced in lateral width toward a front side in a plan view. The outer peripheral edge part 42 of the curved surface 41 has a largest lateral width in a lateral central part of the wide portion 37 in a boundary part (dotted line part of FIG. 4) between the front and rear extending portions 35, 36. As shown in FIG. 2, the curved surface 41 can be visually confirmed through the through hole 23 of the outer plate portion 21.

As shown in FIG. 7, the contact point portion 39 is composed of a top portion 43, a front inclined portion 44 inclined upward from the top portion 43 toward the front side, and a rear inclined portion 45 inclined upward from the top portion 43 toward the rear side. A front-rear length of the front inclined portion 44 is larger than that of the rear inclined portion 45 and exceeds twice that of the rear inclined portion 45. The front inclined portion 44 is arranged on a rear end side of the front extending portion 35. The top portion 43 has a curved shape projecting downward in the boundary part between the front and rear extending portions 35, 36, and has a top 47 in a lowermost part of the resilient contact portion 34, which is a lower end. As shown in FIG. 5, the top portion 43 is arranged to face a central part in the front-rear direction of the receiving portion 22 from above.

The contact point portion 39 includes a gradually thinned portion 46 gradually thinned from the outer peripheral edge part 42 of the curved surface 41 to the top portion 43 to correspond to a recessed shape of the curved surface 41 entirely over the front inclined portion 44, the top portion 43 and the rear inclined portion 45.

As shown in FIG. 7, the gradually thinned portion 46 of the front inclined portion 44 is shaped to have a vertical thickness gradually reduced from the front end of the front inclined portion 44 to the top of the top portion 43 in a side sectional view of the contact point portion 39 cut along the lateral central part. The upper and lower surfaces of the gradually thinned portion 46 of the front inclined portion 44 are inclined toward the top portion 43 at a constant angle of inclination with respect to the front-rear direction. The upper surface of the gradually thinned portion 46 of the front inclined portion 44 constitutes a front part of the curved surface 41. The upper surface of the gradually thinned portion 46 of the front inclined portion 44 has a larger angle of inclination with respect to the front-rear direction than the lower surface of the gradually thinned portion 46 so as to gradually approach the lower surface of the gradually thinned portion 46 from the front end of the front inclined portion 44 to the top 47 of the top portion 43.

The upper surface of the gradually thinned portion 46 of the top portion 43 is a concave surface in a bottom part of the curved surface 41 and continuous with the upper surface of the gradually thinned portion 46 of the front inclined portion 44 without any step. The lower surface of the gradually thinned portion 46 of the top portion 43 is continuous with the lower surface of the gradually thinned portion 46 of the front inclined portion 44 without any step. The top portion 43 constitutes a thinnest part of the gradually thinned portion 46 at a position corresponding to the top 47. The upper surface of the gradually thinned portion 46 of the rear inclined portion 45 has a steeply inclined curved surface shape from the upper surface of the gradually thinned portion 46 of the top portion 43. The lower surface of the gradually thinned portion 46 of the rear inclined portion 45 is continuous with the lower surface of the gradually thinned portion 46 of the top portion 43 without any step and gently inclined upward.

Note that plating such as tin plating is applied to the surface of the terminal fitting 10, and the surface of the terminal fitting 10 is structured such that a pure metal plating layer 48 (shown by a broken line) made of pure metal such as tin is laminated on an alloy plating layer made of tin alloy or the like.

### (Functions of Terminal Fitting)

In manufacturing the terminal fitting 10, the upper surface of a metal plate having the plating applied thereto is first struck and dented by the press-working punch although not shown. A pressing surface of the punch is shaped to correspond to the curved surface 41 of the contact point portion 39. In this way, the metal plate is formed with the contact point portion 39 shaped to bulge downward. The pure metal plating layer 48 on an outermost surface is extended thin by tensile stress associated with bulging on a lower surface side of the contact point portion 39. Subsequently, the metal plate is stamped and further bent, whereby the connecting portion 11 in the form of a rectangular tube and the like are formed and, hence, the terminal fitting 10 is manufactured.

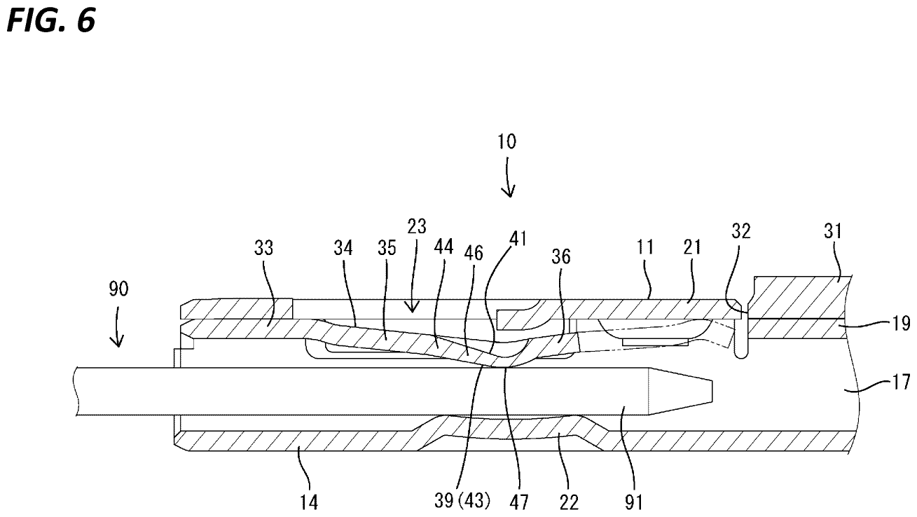

Although not shown, the terminal fitting 10 in a state connected to the end part of the coated wire 60 is inserted into the cavity of the connector housing and retained in the connector housing by the locking lance. Subsequently, when the connector housing is connected to an unillustrated mating connector housing, a tab 91 of a mating terminal fitting 90 is inserted into the connecting portion 11 through an opening on the front end of the connecting portion 11 as shown in FIG. 6. This tab 91 is shaped to extend along the front-rear direction.

In the process of inserting the tab 91 of the mating terminal fitting 90 into the connecting portion 11, the tab 91 enters between the contact point portion 39 and the receiving portion 22 in the front-rear direction and slides on the lower surface of the front inclined portion 44 (in particular, the lower surface of the gradually thinned portion 46 of the front inclined portion 44) and the upper surface of the receiving portion 22. The resilient contact portion 34 is pressed by the tab 91 and resiliently deformed upward with the base end portion 33 as a fulcrum. Thereafter, the tab 91 reaches a position to contact the top 47 of the top portion 43 and the connection of the connector housing and the mating connector housing is completed. At this time, as shown in FIG. 6, the resilient contact portion 34 brings the rear end side of the rear inclined portion 45 into contact with the outer plate portion 21 while being resiliently deformed. The tab 91 is sandwiched between the contact point portion 39 and the receiving portion 22 while being held in contact with the top portion 47 and end parts on both front and rear sides of the receiving portion 22 on the lower surface of the top portion 43. In this way, the terminal fitting 10 and the mating terminal fitting 90 are electrically connected.

In the process of inserting the tab 91 into the connecting portion 11, the tab 91 contacts the front inclined portion 44, receives a resilient reaction force of the resilient contact portion 34 and gradually increases an insertion force. Specifically, the insertion force of the tab 91 gradually increases according to a stroke (contact stroke) from a contact start position where the tab 91 starts to contact the front inclined portion 44 to a contact completion position where the tab 91 contacts the top portion 43.

In the case of this embodiment, since the contact point portion 39 is provided with the gradually thinned portion 46, stress acting on the contact point portion 39 is dispersed in a wide range of the gradually thinned portion 46 while the tab 91 moves from the contact start position to the contact completion position of the contact point portion 39. Thus, the insertion force of the tab 91 can be suppressed to be low. As a result, connection resistance of the connector housing and the mating connector housing can be suppressed to be low and workability during connector connection can be improved. Particularly, in a multi-pole connector in which a multitude of terminal fittings 10 are accommodated in a connector housing, a merit of applying the above configuration for providing the contact point portion 39 with the gradually thinned portion 46 is large.

Further, since the contact point portion 39 having a bulging shape is formed by striking the metal plate by the punch in the case of this embodiment, the pure metal plating layer 48 thinner than the lower surface around the contact point portion 39 is present in the lower surface of the contact point portion 39 as described above. By thinning the pure metal plating layer 48, plating scraping is reduced in amount and generated stress can be reduced when the tab 91 slides on the lower surface of the contact point portion 39. Thus, in the case of this embodiment, the insertion force of the tab 91 can be more reduced by an action to disperse stress by the gradually thinned portion 46 and the thinning of the pure metal plating layer 48.

In the case shown in FIG. 7, if tt denotes a vertical thickness of a thinnest part of the gradually thinned portion 46, i.e. a vertical thickness of the gradually thinned portion 46 along a perpendicular passing through the top 47 of the top portion 43 (plate thickness in the vertical direction, which is a direction in which the resilient contact portion 34 is resiliently deformed) and tf denotes a vertical thickness of a part of the front extending portion 35 connected to the front end of the front inclined portion 44, a relational expression of tt/ft=½ is satisfied. That is, the thickness tt of the top portion 43 of the gradually thinned portion 46 is sufficiently smaller than the plate thickness ft of the front extending portion 35. Thus, an area of the curved surface 41 of the gradually thinned portion 46 increases and stress can be dispersed in a wider range.

FIG. 8 is a grape showing a relationship of the stroke and the insertion force of the tab 91 at a reference (shown by a solid line in FIG. 8) where the contact point portion 39 is not provided with the gradually thinned portion 46 and a relational expression of tt/ft=1 is satisfied, in a pattern A (shown by a dotted line in FIG. 8) where the contact point portion 39 is provided with the gradually thinned portion 46 and the relational expression of tt/ft=½ is satisfied and in a pattern B (shown by a two-dot chain line in FIG. 8) where the contact point portion 39 is provided with the gradually thinned portion 46 and a relational expression of tt/ft=¾ is satisfied in the terminal fitting 10 having a plate thickness of 0.5 mm except in the gradually thinned portion 46.

As shown in the graph of FIG. 8, in the patterns A and B, an insertion peak is significantly lower than at the reference and the insertion force is lower over the entire stroke. Thus, the terminal fitting 10 provided with the resilient contact portion 34 satisfying a relational expression of ½≤tt/ft≤¾ can reduce the insertion force of the tab 91 and, consequently, workability during connector connection can be improved. Note that, in the case of tt/ft<½, the contact point portion 39 becomes excessively thin and it becomes difficult to obtain a contact load of the resilient contact portion 34 and the mating terminal fitting 90. On the other hand, in the case of tt/ft>¾, the insertion force of the tab 91 cannot be reduced from that at the reference by a significant difference, and it becomes difficult to sufficient exhibit the action to disperse stress by the gradually thinned portion 46.

As described above, according to this embodiment, when the resilient contact portion 34 contacts the tab 91 of the mating terminal fitting 90, stress acting on the contact point portion 39 can be widely dispersed in the gradually thinned portion 46 and the insertion force of the tab 91 can be reduced. Therefore, according to this embodiment, it is possible to provide the terminal fitting 10 capable of improving workability during connector connection (at the time of connecting the terminal fitting 10 and the mating terminal fitting 90).

### Other Embodiments of Present Disclosure

The above embodiment disclosed this time should be considered illustrative in all aspects, rather than restrictive.

In the case of the above embodiment, the resilient contact portion includes the contact point portion cantilevered rearward from the base end portion and provided with the gradually thinned portion in the top part of the intermediate part in the front-rear direction. In contrast, according to another embodiment, a resilient contact portion may include a contact point portion cantilevered forward from a base end portion and provided with a gradually thinned portion in a part bent downward on a front end side. Alternatively, a resilient contact portion may be in the form of an arch supported on both ends between base end portions provided on both front and rear end parts of a connecting portion and include a contact point portion provided with a gradually thinned portion in a top part of the arch.

In the case of the above embodiment, the gradually thinned portion is formed over the entire contact point portion. In contrast, according to another embodiment, a gradually thinned portion may be formed only in a front inclined portion of a contact point portion or in the front inclined portion and a top portion, instead of being formed in a rear inclined portion.

In the case of the above embodiment, the gradually thinned portion is formed to be thin by a concave shape of the curved surface provided on the side of the contact point portion opposite to a side to be contacted by the mating terminal fitting. In contrast, according to another embodiment, a gradually thinned portion may be formed to be thin by a concave shape provided on a side of a contact point portion to be contacted by a mating terminal fitting.

List of Reference Numerals

| | |
|---|---|
| 10 | terminal fitting |
| 11 | connecting portion |
| 12 | wire barrel portion |
| | (barrel portion) |
| 13 | insulation barrel portion |
| | (barrel portion) |
| 14 | bottom plate portion |
| 15 | wire barrel piece |
| 16 | insulation barrel piece |
| 17 | side plate portion on one |
| | side (side plate portion) |
| 18 | side plate portion on other |
| | side (side plate portion) |
| 19 | inner plate portion |
| 21 | outer plate portion |
| 22 | receiving portion |
| 23 | through hole |
| 24 | first locking piece |
| 25 | second locking piece |
| 26 | second locking hole |
| 27 | third locking piece |
| 28 | third locking hole |
| 29 | first protrusion |
| 31 | second protrusion |
| 32 | cut portion |
| 33 | base end portion |
| 34 | resilient contact portion |
| 35 | front extending portion |
| 36 | rear extending portion |
| 37 | wide portion |
| 38 | narrow portion |
| 39 | contact point portion |
| 41 | curved surface |
| 42 | outer peripheral edge part |
| 43 | top portion |
| 44 | front inclined portion |
| 45 | rear inclined portion |
| 46 | gradually thinned portion |
| 47 | top |
| 48 | pure metal plating layer |
| 60 | coated wire |
| 61 | coating |
| 62 | core wire |
| 90 | mating terminal fitting |
| 91 | tab |

1. A terminal fitting, comprising:
a tubular connecting portion;
a resiliently deformable resilient contact portion arranged inside the connecting portion; and
a contact point portion provided on the resilient contact portion,
a mating terminal fitting being arranged along a front-rear direction inside the connecting portion through an opening on a front end of the connecting portion, and
the contact point portion including a top portion for contacting the mating terminal fitting and a front inclined portion extending obliquely forward from the top portion, the front inclined portion being provided with a gradually thinned portion gradually thinned toward the top portion.

2. The terminal fitting of claim 1, wherein a surface of the contact point portion on a side opposite to a surface for contacting the mating terminal fitting is a curved surface curved toward a top of the top portion.

3. The terminal fitting of claim 1, wherein:
a pure metal plating layer is formed on a surface of the resilient contact portion, and
a thickness of the pure metal plating layer of the contact point portion is smaller than a thickness of the pure metal plating layer around the contact point portion on the surface of the resilient contact portion facing the mating terminal fitting.

4. The terminal fitting of claim 1, wherein:
the connecting portion includes a receiving portion capable of sandwiching the mating terminal fitting between the resilient contact portion and the receiving portion at a position facing the resilient contact portion,
the resilient contact portion is strip-like, includes a front extending portion extending to approach the receiving portion toward a rear side from a base end portion provided on a front end side of the connecting portion, and is resiliently deformable in a plate thickness direction of the front extending portion with the base end portion as a fulcrum,
the front inclined portion is arranged on a rear end side of the front extending portion, and
a relational expression of ½≤tt/ft≤¾ is satisfied when tt denotes a plate thickness of the top portion.
